(19) United States
(12) Patent Application Publication
(10) Pub. No.: US 2021/0323265 A1
(43) Pub. Date: Oct. 21, 2021

(54) Cellulosic Structures, Methods for Manufacturing Cellulosic Structures, and Liners Formed Therefrom

(71) Applicant: Westrock MWV, LLC, Atlanta, GA (US)

(72) Inventors: John D. BENSON, North Charleston, SC (US); William T. McDONNELL, Elmhurst, IL (US); Joseph COLE, Bonney Lake, WA (US)

(21) Appl. No.: 17/236,116

(22) Filed: Apr. 21, 2021

Related U.S. Application Data
(60) Provisional application No. 62/704,100, filed on Apr. 21, 2020.

(51) Int. Cl. B32B 3/26; B32B 38/04; B65D 65/42; B65D 65/40; B32B 27/10; B32B 27/36; B32B 27/32; B65D 5/20

(52) U.S. Cl. CPC B32B 3/266; B32B 38/04; B65D 65/42; B65D 65/40; B32B 27/10; B32B 2439/70; B32B 27/32; B65D 5/2052; B32B 2255/12; B32B 2038/047; B32B 2255/26; B32B 27/36

(57) ABSTRACT

A cellulosic structure includes a cellulosic substrate having a first major side and a second major side and a first barrier layer on the first major side of the cellulosic substrate. The first barrier layer has a plurality of perforations therethrough.

### PRIORITY

This application claims priority from U.S. Ser. No. 62/704,100 filed on Apr. 21, 2020, the entire contents of which are incorporated herein by reference.

### FIELD

The present application relates to the field of cellulosic structures for packing food prior to freezing.

### BACKGROUND

Liners are used for packing food, e.g. fish or fish products, prior to freezing. Typically, the liners are made from paper-based substrates and are coated on both sides with paraffin layers. These paraffin layers, in connection with the freezing process, contribute to the control of absorption and emission of liquid to and from the paper-based substrates. It is desirable that a certain amount of liquid is absorbed from the food product to the paper-based substrates during the freezing process.

Accordingly, those skilled in the art continue with research and development in the field of cellulosic structures for packing food prior to freezing.

### SUMMARY

In one embodiment, a cellulosic structure includes a cellulosic substrate having a first major side and a second major side and a first barrier layer on the first major side of the cellulosic substrate. The first barrier layer has a plurality of perforations therethrough.

In another embodiment, a method for manufacturing a cellulosic structure includes providing a cellulosic structure, in which the cellulosic structure includes cellulosic substrate having a first major side and a second major side and a first barrier layer on the first major side of the cellulosic substrate, and perforating the first barrier layer.

In yet another embodiment, a liner includes a cellulosic bottom panel having an interior surface and an exterior surface and a plurality of cellulosic side panels connected to the cellulosic bottom panel, in which the plurality of cellulosic side panels has an interior surface and an exterior surface. The liner further includes a first barrier layer on the interior surfaces of the cellulosic bottom panel and the plurality of cellulosic side panels. The first barrier layer has a plurality of perforations therethrough.

Other embodiments of the disclosed cellulosic structures, methods, and liners will become apparent from the following detailed description, the accompanying drawings, and the appended claims.

### BRIEF DESCRIPTION OF THE DRAWINGS

FIG. 1 is a sectional view of an exemplary cellulosic structure according to first exemplary expression of the present description.

FIG. 2 is a sectional view of an exemplary cellulosic structure according to second exemplary expression of the present description.

FIG. 3 is a perspective view of a liner according to an embodiment of the present description.

### DETAILED DESCRIPTION

According to the present description, provided is a cellulosic structure including a cellulosic substrate having a first major side and a second major side. The cellulosic structure may take the form of a sheet of material of a suitable size for the intended application.

The cellulosic substrate may include any substrate comprising cellulose fibers. Preferably, the cellulosic substrate is recyclable. For example, cellulosic substrate may be paper or paperboard.

The cellulosic substrate may include any thickness suitable for the intended application. In an aspect, the caliper thickness of the cellulosic substrate may be 10 point (0.010″) to 40 point (0.040″), for example 15 point (0.015″) to 30 point (0.030″) to provided suitable characteristics for providing a typical liner used for packing food prior to freezing

The first barrier layer and second barrier layer may be applied to the cellulosic substrate by, for example, lamination, coating, or any other process.

The cellulosic structure includes a first barrier layer on the first major side of the cellulosic substrate. The cellulosic structure may further include a second barrier layer on the second major side of the cellulosic substrate. The first and second barrier layers function by substantially reducing or preventing the transport of moisture to the cellulosic substrate. The first barrier layer and the second barrier layer may include any barrier material suitable for application to the cellulosic substrate and suitable for substantially inhibiting water transfer. In an aspect, the first barrier layer and the second barrier preferably have a water transmission rate of at most 30 grams per square meter in a 30-minute water cobb test, more preferably a water transmission rate of at most 15 grams per square meter in a 30-minute water cobb test. Preferably, the first barrier layer and the second barrier layer are formed from a recyclable barrier material. Thus, the whole cellulosic structure may be recyclable. Suitable recyclable barrier materials include, for example, polyethylene terephthalate, polyethylene, and polypropylene.

The first and second barrier layers may have any thickness suitable for substantially reducing or preventing the transport of moisture to the cellulosic substrate. In an example, the first and second barrier layers may include a laminated film having a thickness of 0.0001″ or greater, for example in a range of 0.0005″ to 0.0025″. In another example, the first and second barrier layers may include a coating having a coat weight of 1 lb./3000 ft² or greater.

The first barrier layer includes perforations (e.g. laser perforations or mechanical perforations). The perforations extend through the first barrier layer to expose portions of underlying cellulosic substrate. Thus, the perforations function by absorbing excess amounts of liquid, such as from a food product, prior to freezing, to protect the food product during storage, and to facilitate easy release of the cellulosic structure from the food product prior to use.

The perforations formed in the first barrier layer of the present description have a number of advantages compared to the micro-bubbles of the conventional paraffin coating. The micro-bubbles of the conventional paraffin coating are formed during the coating process and the dimensions and placement of the micro-bubbles are not precisely controlled, whereas the perforations formed in the first barrier layer of the present description are formed after the formation of the first barrier layer and the dimensions and placement of the perforations may be precisely controlled. Additionally, by perforating the first barrier layer, the present description enables for the use of new barrier layer materials, instead of just conventional paraffin, and particularly enables for the use of recyclable barrier layer materials to achieve a whole cellulosic structure that is recyclable. Furthermore, by using perforations, the resulting perforations can be provided at predetermined locations within the first barrier layer, have predetermined and uniform cross-sectional areas, and allow for full penetration of the perforations to the underlying cellulosic substrate to better control the functionality of the penetrations.

The size and distribution of the penetrations may be determined based on the intended application. In an aspect, the penetrations may have an average cross-sectional area of in a range of 1 μm² to 500,000 μm², for example 200 μm² to 50,000 μm². In another aspect, the total cross-sectional area of the penetrations may be within a range of 0.001% to 5% of the cross-section area of the first barrier layer. By way of example, the penetrations may have an average maximum dimension (e.g. dimeter) in a range of 50 to 250 μm, and the penetrations may have a density of about 2 penetrations per square millimeter.

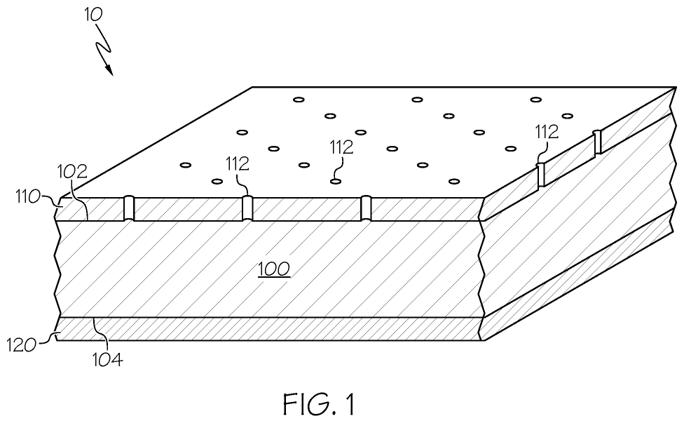

FIG. 1 is a sectional view of an exemplary cellulosic structure according to first exemplary expression of the present description.

As shown in FIG. 1, the cellulosic structure 10 includes a cellulosic substrate 100 having a first major side 102 and a second major side 104, a first barrier layer 110 on the first major side 102 of the cellulosic substrate 100, and a second barrier layer 120 on the on the second major side 104 of the cellulosic substrate 100. The first barrier layer 110 has a plurality of laser or mechanical perforations 112 therethrough.

The first barrier layer 110 and the second barrier layer 120 may be formed by coating the first barrier layer 110 on the first major side 102 of the cellulosic substrate 100 and by coating the second barrier layer 120 on the second major side 104 of the cellulosic substrate 100. Any suitable process for coating the first barrier layer 110 and the second barrier layer 120 may be used. A suitable process for coating the first barrier layer 110 and the second barrier layer 120 includes extrusion coating. After the first barrier layer 110 and the second barrier layer 120 are coated on the cellulosic substrate 100, laser or mechanical perforation is used to form perforations in the first barrier layer 110 to expose portions of the underlying first major side 102 of the cellulosic substrate 100.

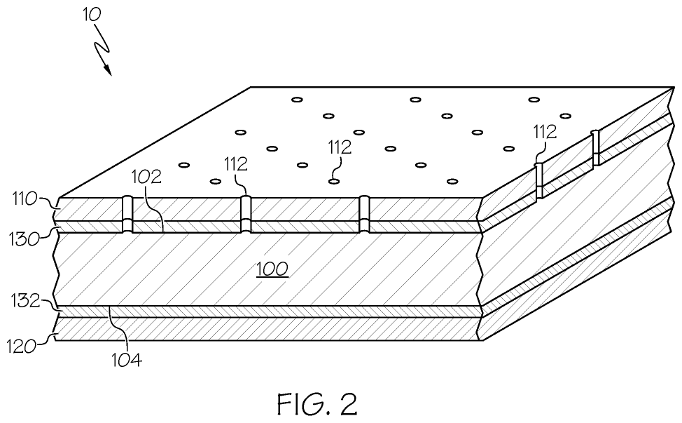

FIG. 2 is a sectional view of an exemplary cellulosic structure according to second exemplary expression of the present description.

As shown in FIG. 2, the cellulosic structure 10 includes a cellulosic substrate 100 having a first major side 102 and a second major side 104, a first barrier layer 110 on the first major side 102 of the cellulosic substrate 100, and a second barrier layer 120 on the on the second major side 104 of the cellulosic substrate 100. A first adhesive layer 130 is positioned between the first barrier layer 110 and the first major side 102 of the cellulosic substrate 100, and a second adhesive layer 132 is positioned between the second barrier layer 120 and the second major side 104 of the cellulosic substrate 100. The first barrier layer 110 and the first adhesive layer 130 have a plurality of laser or mechanical perforations 112 therethrough.

The first barrier layer 110 and the second barrier layer 120 may be formed by laminating the first barrier layer 110 on the first major side 102 of the cellulosic substrate 100 and by laminating the second barrier layer 120 on the second major side 104 of the cellulosic substrate 100. Any suitable process for laminating the first barrier layer 110 and the second barrier layer 120 may be used. A suitable process for laminating the first barrier layer 110 and the second barrier layer 120 includes extrusion lamination. After the first barrier layer 110 and the second barrier layer 120 are coated on the cellulosic substrate 100, laser or mechanical perforation is used to form perforations in the first barrier layer 110 and the first adhesive layer 130 to expose portions of the underlying first major side 102 of the cellulosic substrate 100.

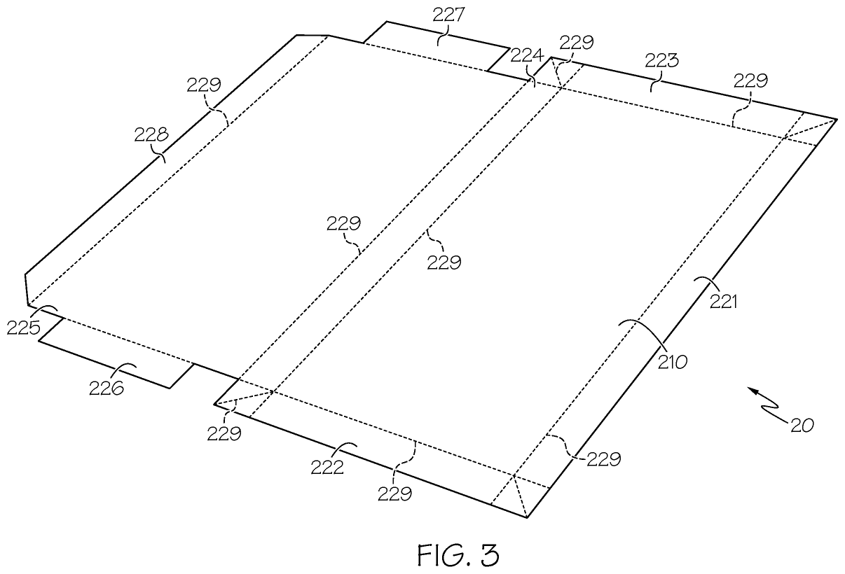

FIG. 3 is a perspective view of a liner according to an embodiment of the present description.

As shown in FIG. 3, the liner 20 includes a cellulosic bottom panel 210 and a plurality of cellulosic side panels 220 connected to the cellulosic bottom panel 210 formed from the cellulosic structure 10 described above with respect to FIGS. 1 and 2. The cellulosic bottom panel 210 and the cellulosic side panels 220 have an interior surface corresponding to the first major side 102 of the cellulosic structure 10 and an exterior surface corresponding to the second major side 104 of the cellulosic structure 10. The first barrier layer 110 is formed on the interior surfaces of the cellulosic bottom panel 210 and the 220 plurality of cellulosic side panels, and the second barrier layer 120 is formed on the exterior surfaces of the cellulosic bottom panel 210 and the 220 plurality of cellulosic side panels. As described above, the first barrier layer has the plurality of laser or mechanical perforations therethrough.

FIG. 3 shows the liner 20 prior to folding. The liner 20 includes a cellulosic front side panel 221 which is, along its one side, connected to the cellulosic bottom panel 210. The cellulosic bottom panel 210 is connected to two cellulosic end side panels 222, 223 and a rear side panel 224. The rear side panel 224 is yet again connected to a rectangular lid panel 225 being, along its side, provided with lid side flaps 226, 227 and along its front edge connected to a lid flap 228. All of the above elements may be connected to each other with folding lines 229 that are shown by dashed lines.

Although various embodiments of the disclosed cellulosic structures, methods, and liners have been shown and described, modifications may occur to those skilled in the art upon reading the specification. The present application includes such modifications and is limited only by the scope of the claims.

What is claimed is:

1. A cellulosic structure comprising:
a cellulosic substrate having a first major side and a second major side; and
a first barrier layer on the first major side of the cellulosic substrate, the first barrier layer having a plurality of perforations therethrough.

2. The cellulosic structure of claim 1 wherein the first barrier layer comprises a coating applied on the first major side of the cellulosic substrate.

3. The cellulosic structure of claim 1 wherein the first barrier layer comprises a film laminated on the first major side of the cellulosic substrate.

4. The cellulosic structure of claim 1 further comprising a second barrier layer on the second major side of the cellulosic substrate.

5. The cellulosic structure of claim 4 wherein the second barrier layer comprises a coating applied on the second major side of the cellulosic substrate.

6. The cellulosic structure of claim 4 wherein the second barrier layer comprises a film laminated on the second major side of the cellulosic substrate.

7. A method for manufacturing a cellulosic structure, the method comprising:
providing a cellulosic structure, the cellulosic structure comprising: a cellulosic substrate having a first major side and a second major side; and a first barrier layer on the first major side of the cellulosic substrate; and
perforating the first barrier layer.

8. The method of claim 7 wherein the step of providing the cellulosic structure comprises coating the first barrier layer on the first major side of the cellulosic substrate.

9. The method of claim 7 wherein the step of providing the cellulosic structure comprises laminating the first barrier layer on the first major side of the cellulosic substrate.

10. The method of claim 7 wherein the provided cellulosic structure further comprises a second barrier layer on the second major side of the cellulosic substrate.

11. The method of claim 10 wherein the step of providing the cellulosic structure comprises coating the second barrier layer on the second major side of the cellulosic substrate.

12. The method of claim 10 wherein the step of providing the cellulosic structure comprises laminating the second barrier layer on the second major side of the cellulosic substrate.

13. The method of claim 7 wherein the step of perforating the first barrier layer is performed by laser perforation.

14. The method of claim 7 wherein the step of perforating the first barrier layer is performed by mechanical perforation.

15. A liner comprising:
a cellulosic bottom panel having an interior surface and an exterior surface;
a plurality of cellulosic side panels connected to the cellulosic bottom panel, the plurality of cellulosic side panels having an interior surface and an exterior surface; and
a first barrier layer on the interior surfaces of the cellulosic bottom panel and the plurality of cellulosic side panels, the first barrier layer having a plurality of perforations therethrough.

16. The liner of claim 15 wherein the first barrier layer comprises a coating applied on the interior surfaces of the cellulosic bottom panel and the plurality of cellulosic side panels.

17. The liner of claim 15 wherein the first barrier layer comprises a film laminated on the interior surfaces of the cellulosic bottom panel and the plurality of cellulosic side panels.

18. The liner of claim 15 further comprising a second barrier layer on the exterior surfaces of the cellulosic bottom panel and the plurality of cellulosic side panels.

19. The liner of claim 18 wherein the second barrier layer comprises a coating applied on the exterior surfaces of the cellulosic bottom panel and the plurality of cellulosic side panels.

20. The liner of claim 18 wherein the second barrier layer comprises a film laminated on the exterior surfaces of the cellulosic bottom panel and the plurality of cellulosic side panels.
